(19) United States
(12) Patent Application Publication
(10) Pub. No.: US 2024/0201110 A1
(43) Pub. Date: Jun. 20, 2024

(54) SYSTEM AND METHOD FOR UTILIZATION OF PHOTON COUNTING IN A CABINET X-RAY SYSTEM

(71) Applicant: KUB TECHNOLOGIES, INC. DBA KUBTEC, Stratford, CT (US)

(72) Inventors: Chester Lowe, Palm Springs, CA (US); Vikram Butani, Fairfield, CT (US)

(73) Assignee: KUB TECHNOLOGIES, INC. DBA KUBTEC, Stratford, CT (US)

(21) Appl. No.: 18/534,588

(22) Filed: Dec. 9, 2023

Related U.S. Application Data
(60) Provisional application No. 63/431,362, filed on Dec. 9, 2022.

(51) Int. Cl. G01N 23/046; G01T 1/24

(52) U.S. Cl. CPC G01N 23/046; G01T 1/244; G01T 1/248; G01N 2223/1016; G01N 2223/419; G01N 2223/6123; G01N 2223/6126

(57) ABSTRACT

The present disclosure relates to the field of a cabinet X-ray incorporating an X-ray tube, an X-ray detector that utilizes photon-counting, and a real-time camera, either high definition or standard resolution, for the production of organic and non-organic images and a system and method wherein the attained X-ray radiograph may be colorized to designate different densities. In particular, the disclosure relates to a system and method with corresponding apparatus for a cabinet x-ray for capturing an X-ray image utilizing a photon counting detector and software allowing a cabinet X-ray unit to attain and optimize images in grayscale and utilizing the photon counts in the various densities of the specimen creating a colorization representing the variation in densities.

### FIELD OF THE PRESENT DISCLOSURE

The present disclosure relates to the field of a cabinet X-ray incorporating a system and method for taking an X-ray image utilizing a photon counting detector.

### BACKGROUND

Today, conventional breast specimen systems can gather a digital breast specimen radiogram and display it in grayscale. In these systems, the radiograms of a tissue or bone specimen are only shown in a grayscale with white distinguishing a very dense item, black distinguishing a non-dense item and various shades of gray distinguishing density level between very dense item and non-dense item, the darker the gray color, the more dense the item.

With a unit incorporating a system and method of utilizing photon counting, the clinician can utilize the resultant image to expeditiously visualize the multitude of densities of the specimen excised from the patient to confirm orientation of the excised sample saving time for both the patient on the treatment table and the clinician.

It would be advantageous in breast procedure rooms to allow the medical professional to operate the cabinet X-ray unit to analyze the excised breast tissue or specimen utilizing the unit to capture an X-ray image captured by a photon counting detector and maybe taken at different energies or techniques of the sample for informational and/or diagnostic purposes. As a result of processing of the multiple projections, a clinician or physician could view the images in the same and exact orientation with different colors denoting a density and construction of the excised tissue.

A major advantage of color or gray scale resolving X-ray Imaging, compared to regular X-ray imaging systems, is the capability to discriminate energy of detected X-rays. This opens the possibility to even recognize different materials in X-ray images. Photons which are in the x-ray spectrum images are measured at different energy discrimination thresholds. The images are then analyzed using software tools and a color or gray scale image is created. Colors or gray scale levels in the image represent different elements in the sample that are of different densities.

The image may then be saved in various formats (e.g., jpeg, .tiff, DICOM, etc.) and resolutions or views and then may be transferred in various resolutions or views in DICOM or any other transmittable format for review.

Specimen radiography is considered the most cost-effective screening method for the detection of breast cancer in surgically removed breast tissue. However, the sensitivity of specimen radiography is often limited by the presence of overlapping dense fibroglandular tissue in the breast specimen. Dense parenchyma reduces the conspicuity of abnormalities and thus constitutes one of the main causes of missed breast cancer diagnosis. The advent of full-field digital detectors offers opportunities to develop advanced techniques for improved imaging of dense breasts.

### SUMMARY

The present disclosure relates to the field of a cabinet X-ray incorporating an X-ray tube and a photon counting detector for the production of organic and non-organic specimen images. The computing device receives video data from the photon detector and determines the orientation and density composition of the specimen based on the captured photon data. This facilitates and aids the surgeon/user in ensuring that the proper amount of tissue has been excised. In particular, the disclosure relates to a system and method with corresponding apparatus for capturing an X-ray image utilizing a photon counting detector allowing a cabinet X-ray unit to attain and optimize images with the colorization radiograph for easier distinction.

The above radiographic images may be colorized to designate differing densities. In one embodiment, the aspects of the present disclosure are directed to a system and method including a cabinet X-ray system incorporating a photon counting detector. This embodiment includes a cabinet X-ray system, a base unit including an image processor and a display, an imaging chain incorporated into the base unit, including an X-ray source with photon-counting detector, a system configured to receive photon data and an interface for enabling an analog/digital signal to be transferred from an image capture apparatus to the image processor of the base unit. The system may be further be configured to supply standard or high-definition (HD) real-time images. A camera can be used to receive video data and may be digital to provide electronic images. The cabinet X-ray system may concurrently capture an X-ray image, photon-counting image, and a real-time image. The camera may be mounted onto the system so as to integrate an exact capture/orientation image of the sample being X-rayed. The unit may be enclosed in a cabinet X-ray system. The unit may be utilized for excised tissue, organ or bone specimens. The unit may be utilized for any organic or inorganic specimen that fits inside the system framework or X-ray cabinet. The image capturing mechanism may be mounted in a cabinet X-ray system, such as the cabinet system illustrated in the embodiment shown in FIG. 1.

In this variation of the above-named embodiments, a photon counting detector is utilized within the same confines of the cabinet as is the multi-spectral x-ray source. Photon counting is a technique in which individual photons are counted using a single-photon detector (SPD). In contrast to a normal photodetector, which generates an analog signal proportional to the photon flux, a single-photon detector emits a pulse of signal every time a photon is detected. The total number of pulses (but not their amplitude) is counted, giving an integer number of photons detected per measurement period. The counting efficiency is determined by the quantum efficiency and any electronic losses that are present in the system.

Many photodetectors can be configured to detect individual photons, each with relative advantages and disadvantages. Common types include photomultipliers, Geiger counters, single-photon avalanche diodes, superconducting nanowire single-photon detectors, transition edge sensors, and scintillation counters. Charge-coupled devices can also sometimes be used. While in appearance they may appear similar in technology and packaging, photon counting eliminates gain noise, where the proportionality constant between analog signal out and number of photons varies randomly. Thus, the excess noise factor of a photon-counting detector is unity, and the achievable signal-to-noise ratio for a fixed number of photons will usually be higher than if the same detector were operated without photon counting.

Photon counting can improve temporal resolution. In a conventional detector, multiple arriving photons generate overlapping impulse responses, limiting temporal resolution to approximately the fall time of the detector. However, if it is known that a single photon was detected, the center of the impulse response can be evaluated to precisely determine the arrival time of the photon.

The method includes controlling the x-ray photon counting detector to collect an x-ray image of the specimen when the x-ray source is energized; determining the counts of detected photons of different areas of the specimen from data collected from the x-ray detector of the projection x-ray image of the specimen when the x-ray source is energized; creating a pixelated x-ray image of the specimen wherein the multiple pixelated areas and their photon counts of the specimen are indicated as a density or range of densities based on the determined density of different areas of the specimen; and selectively displaying the density x-ray image of the specimen on the display in a plethora of pre-determined colors for the operator to observe

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To further clarify the above and other advantages and features of the present disclosure, a more particular description of the disclosure will be rendered by reference to specific embodiments thereof that are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1—Schematically illustrates an exemplary orientation of the X-ray source, specimen, and digital detector as viewed when the door of the cabinet is open, in one embodiment of a system incorporating aspects of the present disclosure.

FIG. 2—Displays an example of an X-ray Cabinet System incorporating aspects of the present disclosure.

FIG. 3—illustrates the pixilation/counting mode utilizing the photon counting detector

FIG. 4A displays a radiographic image of a breast specimen utilizing exemplified embodiments of the present disclosure;

FIG. 4B—displays a radiographic image in a radiographic image colorized utilizing exemplified embodiments of the present disclosure.

FIG. 5—display an embodiment of computer components of embodiments of the present disclosure; and

FIG. 6—illustrate an embodiment of the present disclosure including a top view of an X-ray detector with a specimen thereon.

FIG. 7—illustrates the separation in energy according to the pre-set energy threshold of an object utilizing the photon counting detector

FIGS. 8A, 8B, and 8C—illustrates the different technologies involved in photon counting and the predicated detector.

FIGS. 9A-9C—illustrates shows two-view screening mammograms obtained with the DR photon-counting system show a spiculated mass in the right upper quadrants (arrow). The diagnosis was invasive ductal carcinoma, 8 mm in diameter, as seen on the (a) right craniocaudal image, (b) right mediolateral oblique image, and (c) zoomed in craniocaudal image of the lesion.

FIGS. 10A-10C illustrate how the photon counting technology is utilized in Mammography

### DETAILED DESCRIPTION

In general, aspects of this disclosure include a device (cabinet X-ray system) utilizing an optical camera to capture an optical image (in black and white, gray scale or color, preferably color), preferably in real-time, of a sample or specimen which is also being X-rayed utilizing a multi-spectral source to produce an X-ray image either pixelated utilizing photon-counting, in grayscale via a standard x-ray detector indicating the density of different areas of the sample or specimen, via photon-counting or density detection via ADU preferably with the resulting 2 images being at substantially or, preferably exactly, the same orientation. The X-ray image can include a two-dimensional (2-D) X-ray image or a synthetic X-ray image assembled from more than one X-ray image (e.g., a tomosynthetic image). The above captured image is then colorized to display the differing densities via ADU or photon counting.

Gain on a camera represents the conversion factor from electrons (e−) into digital counts, or Analog-Digital Units (ADUs). Gain is expressed as the number of electrons that get converted into a digital number, or electrons per ADU (e−/ADU).

The photo/captured camera optical image, preferably in real-time, may be displayed on the monitor either overlaid/blended/combination image onto the resultant density colorized or gray scale density X-ray image or synthetic X-ray image assembled from more than one X-ray image (e.g., a tomosynthetic image) of the sample or as back to back viewing on a monitor between at least any two of these images or a side-by-side or Picture-In-a-Picture (PIP) including displayed adjacent to the X-ray image or synthetic X-ray image of the sample. A device capturing both an X-ray image and an optical image, the latter two preferably in real-time, of the specimen facilitates confirmation and orientation for the clinician to verify margins and other specimen features are achieved by the professional after it is removed from a patient.

A preferred embodiment system would be to incorporate an HD (high-definition) optical camera into a cabinet X-ray unit allowing the system to capture an HD optical image and X-ray image either pixelated utilizing a standard x-ray detector or a photon counting detector to display the captured images, in grayscale or colorized of the specimen where the images so obtained can be displayed as disclosed herein.

The present disclosure and embodiments included therein can relate to specimen radiography but the disclosure is not isolated to specimen radiography but may be utilized, for example, for non-destructive testing, pathology as well as any radiographic analysis of organic and non-organic samples or specimens, requiring a cabinet X-ray system but is not limited to just an HD camera but to any camera fitting within the confines of the cabinet X-ray system.

Various x-ray detector to obtain radiographs are utilized to capture x-rays. Common types for standard x-ray radiography are charge integrating devices such as Complementary metal-oxide-semiconductor (CMOS), direct or indirect detection flat panels (Scintillator screen, Amorphous Silicon (a-Si), Amorphous Selenium (a-Se), Charge-coupled devices (CCD).

Common types for photon counting x-ray detectors include photomultipliers, Geiger counter, single-photon avalanche diodes, superconducting nanowire single-photon detectors, transition edge sensors, and scintillation counters. Charge-coupled devices can also sometimes be used. Also, hybrid photon counting technology which uses CMOS or other ASIC technologies.

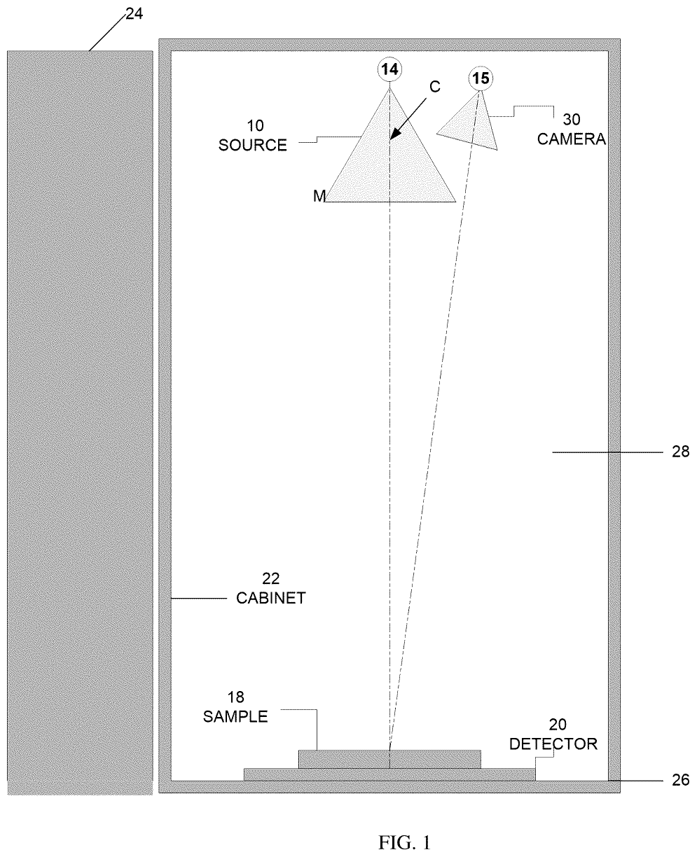

Reference will now be made to figures wherein like structures will be provided with like reference designations. It is understood that the drawings are diagrammatic and schematic representations of exemplary embodiments of the disclosure and are not limiting of the present disclosure nor are they necessarily drawn to scale. FIGS. 1-9 depict various features and uses of embodiments of the present disclosure, which embodiments are generally directed to a system that can utilize an optical camera, preferably an HD or similar real-time camera, to capture an image of the specimen/sample concurrently with the acquisition of an X-ray image utilizing a standard x-ray detector or a photon-counting x-ray detector.

The systems and methods of embodiments of the present disclosure also address unmet needs by providing 2-D X-ray imaging and tomosynthesis apparatus and techniques that include optical imaging for imaging breast specimens that overcome the shortfall of the data received from two-dimensional and tomosynthesis imaging systems alone. The aspects of embodiments of the present disclosure also enable the use of tomosynthesis to efficiently provide accurate three-dimensional imaging of a specimen in which overlapping images having differing attenuation characteristics can be obtained by applying a three-dimensional reconstruction algorithm all in an X-ray cabinet system.

As used herein, the term “computer,” “computer system”, or “processor” refers to any suitable device operable to accept input, process the input according to predefined rules, and produce output, including, for example, a server, workstation, personal computer, network computer, wireless telephone, personal digital assistant, one or more microprocessors within these or other devices, or any other suitable processing device with accessible memory.

The term “computer program” or “software” refers to any non-transitory machine-readable instructions, program or library of routines capable of executing on a computer or computer system including computer readable program code.

Digital breast specimen tomosynthesis is disclosed in U.S. Patent Publication No. 208/0131773 (granted as U.S. Pat. No. 9,138,193), Lowe, et al., entitled “SPECIMEN RADIOGRAPHY WITH TOMOSYNTHESIS IN A CABINET,” the disclosure of which is hereby incorporated by reference in its entirety.

The overlaying of the radiograph and related disclosure; U.S. Patent Publication No. 2019/0117073, entitled “SYSTEM AND METHOD FOR ATTAINING, SAVING, AND TRANSFERRING A COMBINATION/BLENDED IMAGE FROM CABINET X-RAY SYSTEMS,” the disclosure of which is hereby incorporated by reference in its entirety.

The terms “camera” or “optical camera” refer to an instrument, including an optical instrument for capturing images in black and white, gray scale or color (preferably color) using reflected and/or emitted wavelengths of the electromagnetic spectrum, for example, visible light or fluorescent light, from an object, similar to a photograph or that which could be viewed by a human eye, using an electronic light-sensitive sensor array. These terms may include such instruments producing images in standard resolution or HD as well as a digital camera that can directly capture and store an image in computer-readable form using an array of electronic light-sensitive elements—typically semiconductor photo-sensors—that produce a light-intensity-dependent electronic signal in response to being illuminated.

Reference will now be made to figures wherein like structures will be provided with like reference designations. It is understood that the drawings are diagrammatic and schematic representations of exemplary embodiments of the disclosure and are not limiting of the present disclosure nor are they necessarily drawn to scale.

Specimen tomography is a three-dimensional specimen imaging system. It involves acquiring images of a sample at multiple viewpoints, typically over an arc or linear path. The three-dimensional image is constructed by the reconstruction of the multiple image data set.

FIG. 1 schematically illustrates one embodiment of the orientation of the X-ray source 10 as seen when the door 24 is opened and the X-ray source 10 is locate at approximately 0°, reference point 14 in this example, within the X-ray cabinet 22. In this embodiment, the motion of the X-ray source 10 can generally occur from the back to the front of the X-ray cabinet 22 with the detector 20 oriented, or otherwise disposed, at the base 26 of the X-ray cabinet 22, within the X-ray cabinet chamber 28. In one embodiment, the detector 20 is suitably coupled to the base 26 of the X-ray cabinet 22. The X-ray spread in this example can be from about 0 kVp to about 50 kVp with the system preferably utilizing an AEC (Automatic Exposure Control) to ascertain the optimal setting to image the object or sample 11 being examined.

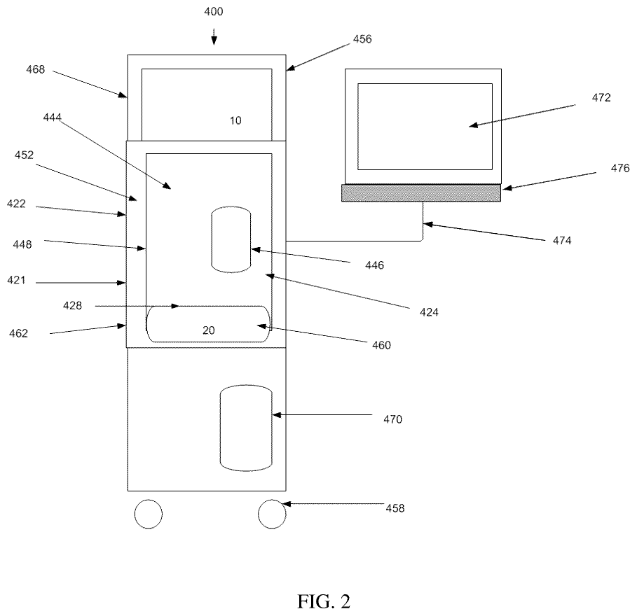

In one embodiment, the detector 20, X-ray source 10, and the swing arm 60 servo mechanism are controlled via a combination of one or more of software and hardware, such as non-transitory machine-readable instructions stored in a memory that are executable by one or more processors. On example of such a configuration can include controller cards of a computer 470 (FIG. 2), such as a MS Windows based computer. In one embodiment, non-transitory machine readable instructions being executed by one or more processors of the computer 470 is utilized to compile data received from the detector 20 and present resulting images to a suitable display or monitor 472 at each imaging position, such as positions 12, 14 and 16 shown in FIG. 1, the detector 20 generates the respective digital values for the pixels in a two-dimensional array. The size of detector 20 may range, for example, from about 5.08 centimeters by 5.08 centimeters to about 40.64 centimeters by 40.64 centimeters, preferably about 12.7 centimeters by 8.24 centimeters. In one example, detector 20 has a rectangular array of approximately 836×1944 pixels with a pixel size of 74.8 micrometers. The image dataset attained at each respective position may be processed either at the full spatial resolution of detector 20 or at a lower spatial resolution by overlapping or binning a specified number of pixels in a single combined pixel value.

For example, if we bin at a 2×2 ratio, then there would be an effective spatial resolution of approximately 149.6 micrometers. This binning may be achieved within the original programming of the detector 20 or within the computer 470 providing the tomosynthetic compilation and image.

FIG. 2 shows one embodiment of an X-ray Cabinet System 400 incorporating aspects of the present disclosure. In this embodiment, the X-ray Cabinet System 400 is mounted on wheels 458 to allow easy portability. In alternate embodiments, the X-ray Cabinet System 400 can be mounted on any suitable base or transport mechanism. The cabinet 422 in this example, similar to the exemplary X-ray cabinet 22 of FIG. 1, is constructed of a suitable material such as steel. In one embodiment, the cabinet 422 comprises painted steel defining a walled enclosure with an opening or cabinet chamber 428. Within the cabinet chamber 428, behind door 424, resides an interior space forming a sample chamber 444, which in this example is constructed of stainless steel. Access to the sample chamber 444 is via an opening 446. In one embodiment, the opening 446 of the sample chamber 444 has a suitable door or cover, such as a moveable cover 448. In one embodiment, the moveable cover 448 comprises a door which has a window of leaded glass.

Between the outer wall 421 of cabinet 422 and the sample chamber 444 are sheets of lead 452 that serve as shielding to reduce radiation leakage emitted from the X-ray source 10. In the example of FIG. 2, the X-ray source 10 is located in the upper part 456 of the cabinet 422, in the source enclosure 468. The detector 20 is housed in the detector enclosure 460 at an approximate midpoint 462 of the cabinet 422.

In one embodiment, a controller or computer 470 controls the collection of data from the detector 20, controls the swing arm 60 and X-ray source 10. A monitor 472 displays the compiled data and can, for example, be mounted on an articulating arm 474 that is attached to the cabinet 422. The computer 470 receives commands and other input information entered by the operator via a user interface 476, such as a keyboard and mouse for example. In one embodiment, the computer 470 can comprise a touch screen or near touch screen device. Although the aspects of the disclosed embodiments will generally be described with respect to a computer 470, it will be understood that the computer 470 can comprise any suitable controller or computing device. Such computing devices can include, but are not limited to, laptop computers, minicomputers, tablets and pad devices.

The computer 470 can be configured to communicate with the components of the X-ray cabinet system 400 in any suitable manner, including hardwired and wireless communication. In one embodiment, the computer 470 can be configured to communicate over a network, such as a Local Area Network or the Internet.

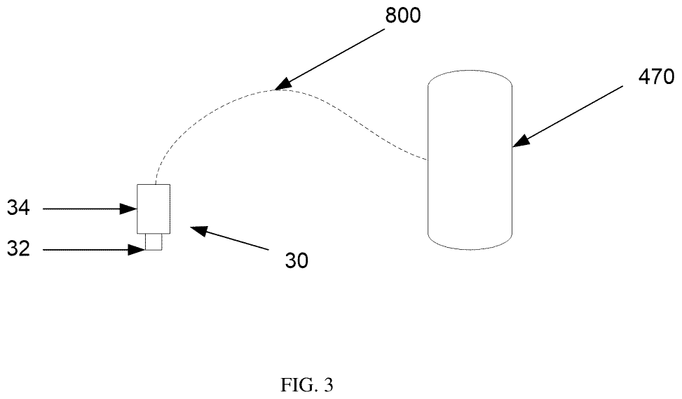

The aspects of the disclosed embodiments are generally directed to a system that can utilize an optical camera, preferably a real-time camera, to capture a visual image of a specimen/sample concurrently or at substantially the same time as the acquisition of an X-ray image. Referring to FIG. 3, there is shown the interconnection of an embodiment of a camera 30 incorporated into a Cabinet X-Ray Unit which connects to and can be controlled by the computer 470 via cable 800 including, for example a USB cable. Other wireless formats for communication between camera 30 and computer 470 can also be used in embodiment of the present disclosure. Camera 30 may include an optical lens assembly 32 through which an optical image passes and is focused upon an electronic light-sensitive sensory array included in the camera body 34. The optical image can then be sent using an electronic signal from the sensory array to the computer 470 via cable 800 or other wireless formats. The optical image as well as a 2-D X-ray image or tomosynthesis image can also be stored in the computer 470 for future examination and viewing, including storage in memory (e.g., RAM) or a disc recording medium (e.g., CD, DVD, etc.)

In the systems and methods included in this disclosure as well as the embodiments disclosed herein, the resulting X-ray generated and optical camera images can be displayed each alone or together as overlaid/blended together, adjacent or PIP (Picture-in-Picture) on the monitor—472 of FIG. 2. This, in turn, provides more flexibility for a clinician or other user of the system and simplifies the procedure. The separate images from the camera and X-ray detector separately as well as the tomosynthetic, overlaid/blended, adjacent and PIP images can be stored in the computer hard drive on the system 470 or a separate memory device, such as for example, a separate hard drive, flash drive, CD-ROM, DVD, etc. for future analysis. The camera can capture a visible light or other electromagnetic wavelength reflected or emitted by the sample or portions thereof, for example, though the use of fluorescent or other markers using a suitable light source where required. Manual input for operation of the cabinet X-ray unit may be initiated via keyboard or monitor touch screen and the resulting image from both the manual-initiated examination can be displayed on the screen and configured in accordance with one example embodiment of the present disclosure.

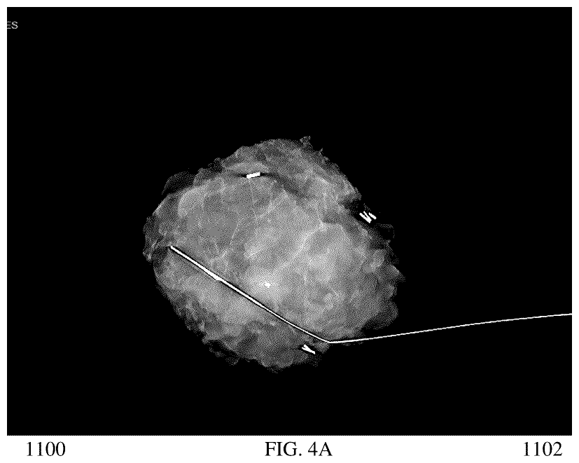

FIG. 4A shows an X-ray image of a breast specimen, a gray scale X-ray image produced directly from the X-ray source and X-ray detector of the embodiments of the present disclosure, and FIG. 4B shows the blend/overlaid/blended image of the X-ray image of FIG. 4A overlaid/blended/blended onto the optical image of the specimen 1104 showing the actual placement of the markers 1102 and orientation of the specimen as well as placement of the markers 1102 within the breast specimen 1100. Markers 1102 are utilized to delineate the outer boundaries of the suspect area that needs to be excised in the X, Y, and Z directions. The markers may include radioactive seeds, coils, wires, and/or radiopaque/visible items which are implanted before the surgery by an interventional radiologist prior to the surgery and are utilized to denote boundaries of the region of interest.

FIG. 4B shows the original grayscale X-ray image from FIG. 4A after the computer 470 has analyzed the different densities or ranges of densities and has assigned a color to them. Specifically, with FIG. 4A, it is colorized with various shades of red being the densest areas going to white being the least dense. Blue and Purple are displayed in FIG. 4A in varying intensities to convey to the medical professional (e.g., surgeon or other medical doctor) viewing the image the differences of densities of the specimen shown in the image.

For exemplary descriptive purposes, in a normal X-ray or tomosynthetic image (i.e., before the densities of the different area of the specimen are determined and an image produced therefrom), there can be five different densities that can be useful to determine the nature of an abnormality (e.g., air, fat, soft tissue, bone and metal). If there is an unexpected increase or decrease in the density of a known anatomical structure then this may help determine the tissue structure of the abnormality. Low density material such as air is represented as black on the normal X-ray or radiograph image. Very dense material such as metal or contrast material is represented as white. Bodily tissues are varying degrees of gray, depending on density, and thickness. Utilizing artificial intelligence and neural networks, the algorithm of embodiments of the present disclosure can take the varying degrees of gray of a normal X-ray image and interpolates them in a color palate or gray scale where the different colors or shades of gray indicate different densities or a range of densities of areas of the specimen. Changes in color can be more easily perceived than changes in shades of gray of the initial X-ray image and therefore this procedure makes the interpretation and understanding of the image easier for a medical professional (e.g., surgeon or other medical doctor). During colorization, for example, the algorithm replaces a scalar value representing pixel's intensity with a vector in a given color space. Since the mapping between intensity and color has no inherently correct solution, human interaction and external information usually plays a large role in evaluating the original X-ray image.

One embodiment of the present disclosure utilizes a controller or computer of embodiments of the present disclosure, for example a controller or computer 470 in FIG. 2, to control, manage, manipulate and analyze the image data obtained by the cabinet X-ray system or unit and other embodiments of the present disclosure in order to analyze the different densities of a specimen and assigning a color to each of those densities. One embodiment for obtaining and analyzing the different densities of a specimen and assigning a color to each of those densities includes beaming X-rays through tissue of a specimen and measuring their magnitude (i.e., intensity) after they have passed through the specimen utilizing an X-ray detector, for example, X-ray detector 20, the X-ray detector including, for example, a plurality of pixels including a two-dimensional array of pixels used to detect incoming X-rays emitted from an X-ray source, for example, X-ray source 10 of embodiments of the present disclosure. Some of the pixels will detect X-rays Since denser materials like bone will attenuate (weaken the energy) the X-rays more than soft tissue does, their shape becomes clear as a flat, monochrome image in the colorized image embodiments of the present disclosure. The detector can measure the attenuation of specific wavelengths of the X-rays as they pass through different materials. In normal X-ray images, the above is visualized utilizing gray scale. One embodiment for generating the image where the darkness of the gray scale is for more dense areas or different colors denoting the density of different areas, uses an algorithm to record the magnitude (i.e., intensity) of each pixel of the detector that is received by the detector and based on the magnitude (i.e., intensity) being emitted from the X-ray source, for example, X-ray source 10, determines the difference in magnitude between the source and what is received by the detector. An algorithm, different or incorporated into other algorithms disclosed herein, can use that information on the difference from each pixel of the detector to produce an image whereby the quantity of the difference in magnitude (i.e., intensity) at each pixel and a specific color (or shades of a color) or gray scale level is assigned to each such difference or range of differences in magnitude (i.e., intensity) for all the pixels and an image is then displayed of the specimen in those colors, shades of color or gray scale showing the different densities or range of densities of parts of the specimen. For example, after running the data through the specific algorithms, a color image can generated that shows muscle, bone, water, fat, disease markers so that their presence in the specimen can then be determined. That means two objects of similar density but different materials can be distinguished.

Separate image layers for each material, for example, one layer containing only bone, one containing only fat, etc. of the original X-ray image can be assigned a color (or color range) or gray scale level for each material of the specimen. Any color can be chosen, but in one embodiment, colors can be chosen that look similar to what one would expect to see in the specimen itself. Once the colors (or color range) or gray scale for the different densities or range of densities are chosen, the different colors (or color range) or gray scale for those areas of the specimen are combined to produce a single color or gray scale image. Such images can also be adjusted to edit out one or more specific density amounts or range of density amounts, thus, only showing in an image, those densities or range of densities that a medical professional (e.g., surgeon or other medical doctor) desires to examine and have in the image.

Cabinet X-ray systems or units of the present disclosure can operate by analyzing the ADU (analog-to-digital) units that are the formation of all photographs whether they be radiographs or photographs. Such embodiments can minutely compare the differences between neighboring pixels in terms of magnitude and succinctly assigns a color, shade of color or gray scale level to each density or range of densities after assigning a color or gray scale for full black and one for full white.

A radiographic image is composed of a ‘map’ of X-rays that have either passed freely through the specimen or have been variably attenuated (absorbed or scattered) by anatomical structures. The denser the tissue, the more X-rays are attenuated. For example, X-rays are attenuated more by bone than by lung tissue. Contrast within the overall image depends on differences in both the density of structures in the body and the thickness of those structures. The greater the difference in either density or thickness of two adjacent structures leads to greater contrast between those structures within the image.

Another embodiment of the cabinet X-ray systems or units of the present disclosure can distinguish different material of the specimen by training or including an algorithm to analyze the system imaging the specimen using the same technique, kVp and mA (the mA (tube current and exposure time product) and filtration, kVp (tube voltage), two settings that can be adjusted on X-ray system to control the image quality and patient dose. The algorithm would need to be calibrated and it would record the ADU unit for each density/material in the specimen and utilizing a table or other list in memory of information on the densities of different material, discern the different materials making up the specimen.

Another embodiment of the present disclosure can use the difference in X-ray magnitude from each pixel that indicates the density of area of the specimen in a 2-D X-ray and then using that difference (e.g., either from the difference data directly or from 2-D density X-ray images formed using that data) from multiple such 2-D X-ray images of the same specimen area to generate a colorized tomosynthetic image denoting density in that tomosynthetic image.

The detailed images of the embodiments of the present disclosure can be viewed in real-time and/or saved for future examination in various formats in the main computer 470 and then may be transmitted via USB, ethernet, Wi-Fi, etc. in various formats that may include DICOM, .tiff. or .jpeg, non-inclusive.

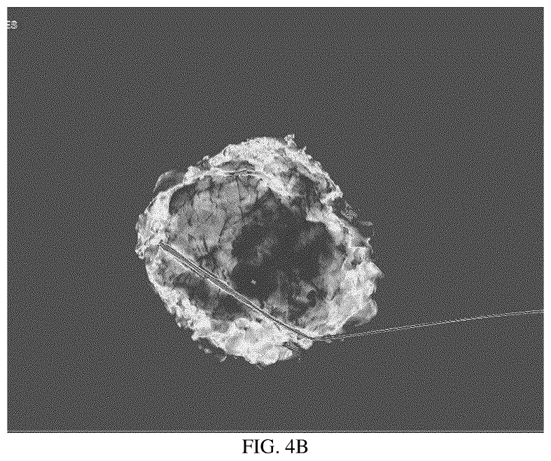

One embodiment of the cabinet X-ray system or unit of the present disclosure includes a controller or computer, for example a controller or computer 470 in FIG. 24 that includes a processing unit 102 as shown in FIG. 5, a digital detector 103 for collecting an X-ray image of, for example, a breast specimen radiogram, the X-ray radiogram from a tomosynthesis specimen radiographic system as well as previous figures and disclosure included above and entered at an input 112 to the cabinet X-ray system or unit embodiments of the present disclosure. The processing unit 102 generally includes elements necessary for performing image processing including parallel processing steps of embodiments of the present disclosure. The tomosynthesis specimen radiogram may be one of a plurality of such radiograms that can be used to produce tomosynthetic images. The colorizing of X-ray images or tomosynthetic images to indicate density or a range of densities is another use of the processing unit. In particular, the processing unit 102 includes elements such as a central control unit 105, a memory 108, a parallel processing unit 110, and I/O (input/output) unit 112. The central control unit 105 performs the commands to manipulate the data. Memory 108 performs the temporary storage and manipulation of the data as well as storage of algorithms and other software used by the cabinet X-ray system or unit or other embodiments of the present disclosure in performing aspects of the embodiments, methods and systems included herein. Parallel processing unit 110 performs and allows simultaneous calculating, and notation of all images as well as management and manipulation of the data utilizing algorithms and other software used by the cabinet X-ray system or unit or other embodiments of the present disclosure in performing aspects of the embodiments, methods and systems included herein. I/O (input/output) unit 112 performs control of the input data and the resulting output/display. It is to be appreciated that the parallel processing unit 110 shown in FIG. 5 may be replaced by a single processor without departing from the scope of the preferred embodiments. It is to be appreciated that in addition to the image analysis and manipulation algorithms disclosed herein, processing unit 102 is capable of performing a multiplicity of other image processing algorithms either serially or in parallel therewith.

Display or monitor 472 is for conveniently viewing both images of embodiments of the present disclosure and the output of the processing unit 102 thereon. Display or monitor 472 may also include a user interface as user interface 476 exemplified in the embodiment of FIG. 2, such as a keyboard and mouse for example. In one embodiment. Display or monitor 472 can comprise a touch screen or near touch screen device separately or integrated as part thereof. Display or monitor 472 may be, for example, an LCD screen. As used herein, the term “display” or “monitor” means any type of device adapted to display information, including without limitation CRTs, LCDs, TFTs, plasma displays, LEDs, and fluorescent devices. Display or monitor 472 typically shows any of the images included in the embodiments of the present disclosure.

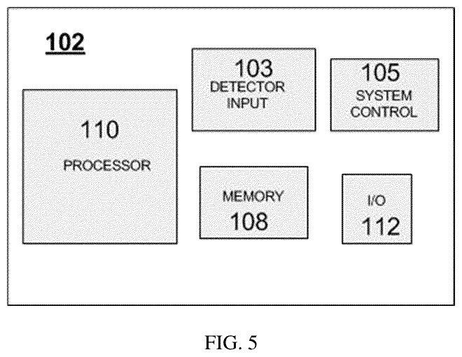

Embodiments of the present disclosure can be illustrated in FIG. 6 that includes the top view of an X-ray detector 1300 with pixels 1302A, 1302B and 1302C and resting thereon (either directly or indirectly, e.g., a cover) a specimen 1304. A side view of the detector and specimen is similar to what is illustrated in FIG. 1. When both X-ray detector 1300 and a specimen 1304 are exposed to an X-ray source or X-ray sources, pixels 1302A, 1302B and 1302C detect the magnitude (i.e., intensity) X-rays as described herein. Specimen 1304 includes as part thereof an area 1306 having one density and within area 1306 another region 1308 with an area 1310 having a different density. Pixels 1302A will detect the incoming X-rays unaffected (e.g., unattenuated). Pixels 1302B will detect the incoming X-rays effected (e.g., attenuated) by the density of area 1306. Pixels 1302 will detect the incoming X-rays effected (e.g., attenuated) by the density of area 1306.

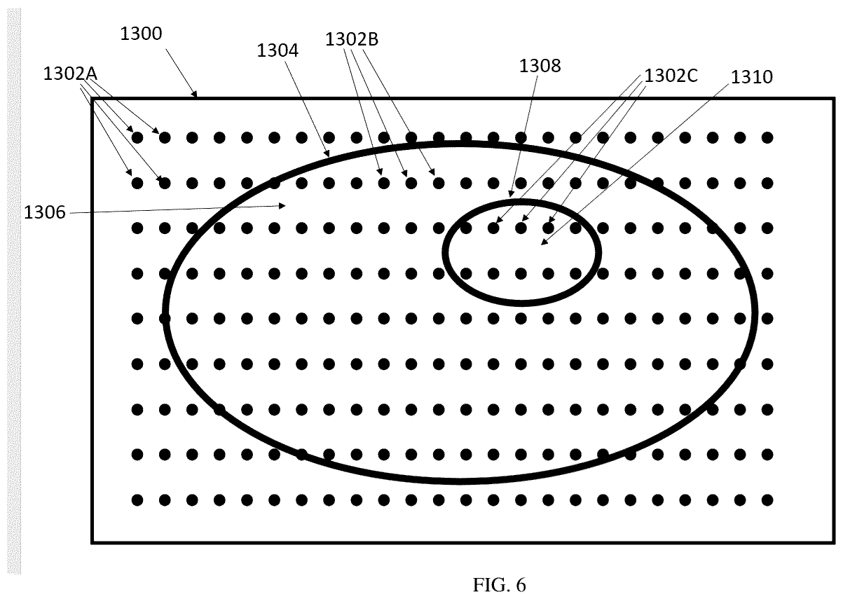

In the embodiment utilizing photon-counting, FIG. 7 exhibits the x-ray source, 1400, which projects a multi-spectral waveform onto the specimen, 1402, which is captured by the detector 1404. The resulting compilation of the photon count as the related to the differing densities are exhibited by 1406, 1408, 1410, 1412 from the least dense to the densest. A pre-set energy threshold allows to capture just one part of the X-ray spectrum. The difference in densities even can change with changing the threshold.

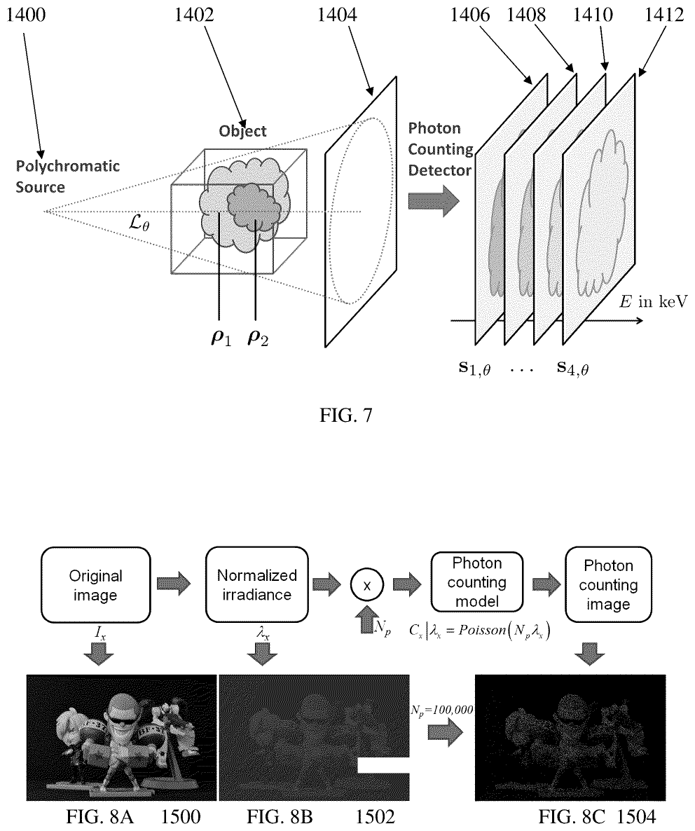

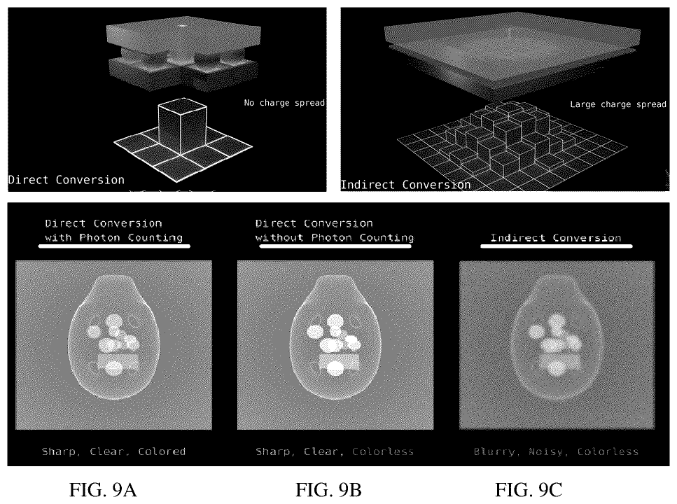

In the next series of images FIG. 8A-9C, it is shown the 3 phases of an image, Standard HD Image 1500, Standard Radiograph 1602, and the pixilated photon-counted image 1504

FIG. 9A shows how a standard x-ray detector captures and image and the resulting resolution and FIGS. 9B and 9C exhibit more information and higher resolution achieved from a photon-counting detector.

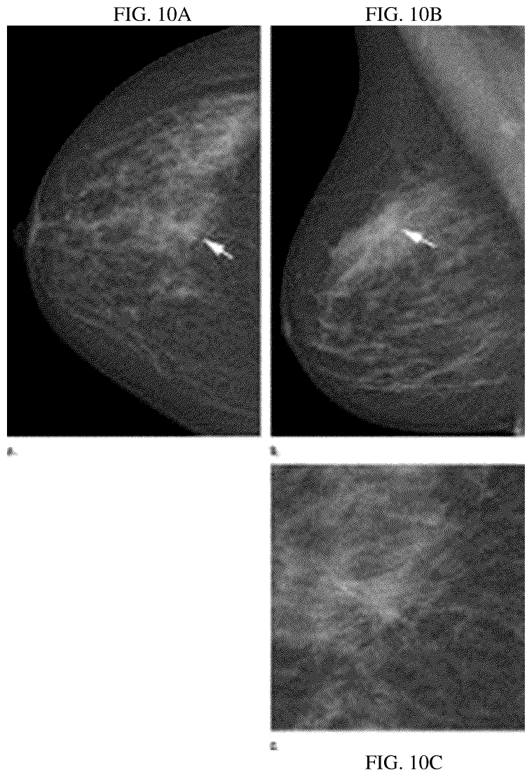

FIGS. 10A, 10B, and 10C show how the photon counting technology is utilized in Mammography. The above shows two-view screening mammograms obtained with the DR photon-counting system show a spiculated mass in the right upper quadrants (arrow). The diagnosis was invasive ductal carcinoma, 8 mm in diameter, as seen on the (a) right craniocaudal image, (b) right mediolateral oblique image, and (c) zoomed in craniocaudal image of the lesion. (Weigel, S., Berkemeyer, S., Girnus, R., Sommer, A., Lenzen, H., & Heindel, W. (2014). Digital Mammography Screening with Photon-counting Technique: Can a High Diagnostic Performance Be Realized at Low Mean Glandular Dose? Radiology, 271(2), 345-355. doi:10.1148/radiol.13131111).

Indeed, it is appreciated that the system and its individual components can include additional features and components, though not disclosed herein, while still preserving the principles of the present disclosure. Note also that the base computer can be one of any number devices, including a desktop or laptop computer, etc.

Aspects of the present disclosure may be embodied in other specific forms without departing from its spirit or essential characteristics. The described embodiments are to be considered in all respects only as illustrative, not restrictive. All changes that come within the meaning and range of equivalency of the claims are to be embraced within their scope.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While there have been shown, described and pointed out, fundamental features of the present disclosure as applied to the exemplary embodiments thereof, it will be understood that various omissions and substitutions and changes in the form and details of compositions, devices and methods illustrated, and in their operation, may be made by those skilled in the art without departing from the spirit or scope of the present disclosure. Moreover, it is expressly intended that all combinations of those elements and/or method steps, which perform substantially the same function in substantially the same way to achieve the same results, are within the scope of the present disclosure. Moreover, it should be recognized that structures and/or elements and/or method steps shown and/or described in connection with any disclosed form or embodiment of the present disclosure may be incorporated in any other disclosed or described or suggested form or embodiment as a general matter of design choice. It is the intention, therefore, to be limited only as indicated by the scope of the claims appended hereto.

What is claimed is:

1. A cabinet x-ray image system for obtaining x-ray images and colorized or grey scale density x-ray images of a specimen, the system comprising:
a cabinet defining an interior chamber wherein the cabinet comprises a walled enclosure surrounding the interior chamber, a door configured to cover the interior chamber and a sampling chamber for containing the specimen;
a display;
an x-ray system including:
an x-ray source;
a photon-counting detector; and
a specimen platform; and
a controller configured to:
selectively energize the x-ray source to emit x-rays through the specimen to the x-ray detector;
control the x-ray detector to collect a projection x-ray image of the specimen when the x-ray source is energized;
determine the density of different areas of the specimen from data collected from the x-ray detector of the projection x-ray image of the specimen when the x-ray source is energized;
create a density x-ray image of the specimen wherein the different areas of the specimen are indicated as a density or range of densities based on the determined density of different areas of the specimen; and
selectively display the density x-ray image of the specimen on the display.

2. The cabinet x-ray image system of claim 1, wherein the specimen platform is configured for excised tissue, organ or bone specimens.

3. The cabinet x-ray image system of claim 1, wherein the specimen platform is configured for any organic or inorganic specimen that fits inside an x-ray cabinet.

4. The cabinet x-ray image system of claim 1, wherein the cabinet x-ray image system further includes:
an optical camera configured to capture an optical image of the specimen; and
the controller is further configured to:
control the optical camera system to capture and collect the optical image of the specimen; and
selectively display the density x-ray image and the optical image of the specimen on the display.

5. The cabinet x-ray image system of claim 4, wherein the density x-ray image and the optical image of the specimen are displayed overlaid.

6. The cabinet x-ray image system of claim 1, further comprising:
the x-ray source emits a first amount of x-rays;
the x-ray detector includes a plurality of pixels in an array, each pixel configured to detect a second amount of x-rays received by the pixel; and
the controller is further configured to:
create the density x-ray image from the plurality of pixels by comparing from the first amount of x-rays and the second amount of x-rays for each pixel in the array.

7. The cabinet x-ray image system of claim 1, wherein the different areas of the specimen of the density x-ray image are displayed in different grey scale, different color or different shades of color.

8. A method for obtaining x-ray images and colorized or grey scale density x-ray images of a specimen using a cabinet x-ray image system, wherein the cabinet x-ray image system comprises:
a cabinet defining an interior chamber wherein the cabinet comprises a walled enclosure surrounding the interior chamber, a door configured to cover the interior chamber and a sampling chamber for containing the specimen;
a display;
an x-ray system including:
an x-ray source;
a photon-counting detector; and
a specimen platform; and
a controller configured to:
selectively energize the x-ray source to emit x-rays through the specimen to the x-ray detector;
control the x-ray detector to collect a projection x-ray image of the specimen when the x-ray source is energized;
determine the density of different areas of the specimen from data collected from the x-ray detector of the projection x-ray image of the specimen when the x-ray source is energized;
create a density x-ray image of the specimen wherein the different areas of the specimen are indicated as a density or range of densities based on the determined density of different areas of the specimen; and
selectively display the density x-ray image of the specimen on the display, wherein the method comprises:
controlling the x-ray detector to collect an x-ray image of the specimen when the x-ray source is energized;
determining the density of different areas of the specimen from data collected from the x-ray detector of the projection x-ray image of the specimen when the x-ray source is energized;
creating a density x-ray image of the specimen wherein the different areas of the specimen are indicated as a density or range of densities based on the determined density of different areas of the specimen; and
selectively displaying the density x-ray image of the specimen on the display.

9. The method of claim 8, wherein the cabinet x-ray image system further includes:
an optical camera configured to capture an optical image of the specimen;
the controller is further configured to:
control the optical camera system to capture and collect the optical image of the specimen; and
selectively display the density x-ray image and the optical image of the specimen on the display; and
the method further includes
controlling the optical camera system to capture and collect the optical image of the specimen; and
selectively displaying the density x-ray image and the optical image of the specimen on the display.

10. The method of claim 8, wherein the density x-ray image and the optical image of the specimen are displayed overlaid.

11. A method for obtaining x-ray images and colorized or grey scale density x-ray images of a specimen using a cabinet x-ray image system, wherein the cabinet x-ray image system comprises:
a cabinet defining an interior chamber wherein the cabinet comprises a walled enclosure surrounding the interior chamber, a door configured to cover the interior chamber and a sampling chamber for containing the specimen;
a display;
an x-ray system including:
an x-ray source;
a photon-counting detector; and
a specimen platform; and
a controller configured to:
selectively energize the x-ray source to emit x-rays through the specimen to the photon-counting detector;
control the photon-counting detector to collect a projection x-ray image of the specimen when the x-ray source is energized;
determine the density of different areas of the specimen from data collected from the photon-counting detector of the projection x-ray image of the specimen when the x-ray source is energized;
create a density x-ray image of the specimen wherein the different areas of the specimen are indicated as a density or range of densities based on the determined density of different areas of the specimen; and
selectively display the density x-ray image of the specimen on the display, wherein the method comprises:
controlling the photon-counting detector to collect an x-ray image of the specimen when the x-ray source is energized;
determining the density of different areas of the specimen from data collected from the x-ray detector of the projection x-ray image of the specimen when the x-ray source is energized;
creating a density x-ray image of the specimen wherein the different areas of the specimen are indicated as a density or range of densities based on the determined density of different areas of the specimen; and
selectively displaying the density x-ray image of the specimen on the display.

12. The method of claim 11, wherein the cabinet x-ray image system further includes:
an optical camera configured to capture an optical image of the specimen;
the controller is further configured to:
control the optical camera system to capture and collect the optical image of the specimen; and
selectively display the density x-ray image and the optical image of the specimen on the display; and
the method further includes
controlling the optical camera system to capture and collect the optical image of the specimen; and
selectively displaying the density x-ray image and the optical image of the specimen on the display.

13. The method of claim 11, wherein the x-ray detector utilized performs photon-counting.

14. The method of claim 13, wherein the photon-counting detector may be photomultipliers, Geiger counters, single-photon avalanche diodes, superconducting nanowire single-photon detectors, transition edge sensors, CCD, scintillation counters, and hybrid pixel photon counting detectors

15. The method of claim 14, wherein the different areas of the specimen of the that are photon-counted are displayed in different grey scale, different color or different shades of color.
